(19) United States
(12) Patent Application Publication
(10) Pub. No.: US 2024/0367767 A1
(43) Pub. Date: Nov. 7, 2024

(54) A SYSTEM AND A METHOD OF DETECTION AND DELINEATION OF CONDUCTIVE BODIES SITUATED UPON AND/OR BENEATH THE SEAFLOOR

(71) Applicant: Argeo Robotics AS, Hvalstad (NO)

(72) Inventors: Johan Mattsson, Trångsund (SE); Anna LIM, Oslo (NO)

(21) Appl. No.: 18/687,280

(22) PCT Filed: Aug. 31, 2022
(86) PCT No.: PCT/NO2022/050205

§ 371 Date: Feb. 27, 2024

(30) Foreign Application Priority Data
Aug. 31, 2021 (NO) 20211043

(51) Int. Cl. B63G 8/00; G01V 3/165; G01V 3/17; G01V 3/36

(52) U.S. Cl. CPC B63G 8/001; G01V 3/165; G01V 3/17; G01V 3/36; B63G 2008/004

(57) ABSTRACT

A system and method for detection and delineation of conductive bodies situated upon or beneath the seafloor, comprising: at least one source Autonomous Underwater Vehicle (AUV) having a hull and at least one receiver (AUV) having a hull, the source AUV comprising: at least one controlled electric dipole source mounted on the hull of the source AUV; at least one first magnetometer mounted inside the hull of the source AUV; the receiver AUV comprising; at least one first receiver electrodes; at least one second receiver electrodes; at least one second magnetometers mounted inside the hull of the AUV; measurement electronics hosted inside the receiver AUV; wherein the first and the second magnetometers are configured to measure the magnetic field and the first and the second receiver electrodes are configured to measure electric field in a horizontal direction relative to the AUV, x-direction, and a vertical direction relative to the AUV, z-direction, when electromagnetic energy is transmitted from the controlled electric dipole source, the system further comprising: source electronics hosted inside the source AUV and connected to the two electrode plates with cables through the hull adapted to operate the electric dipole source, in the source AUV and the receiver AUV a battery for powering the electric dipole source, first and second receivers, source and measurement electronics and the magnetometer, in the source AUV and receiver AUV measurement electronics adapted to operate the receiver electrodes and the first and the second magnetometers.

### CROSS-REFERENCE TO RELATED APPLICATIONS

The present application claims the priority of PCT application No. PCT/NO2022/050205, filed Aug. 31, 2022, and which claims the priority of Norwegian patent application No. NO20211043, filed Aug. 31, 2021, the disclosures of which are incorporated by reference herein in their entireties.

### BACKGROUND

### Technical Field

The present disclosure relates to a system for detection and delineation of conductive bodies situated upon and/or beneath the seafloor and a method of detection and delineation of conductive bodies situated upon and/or beneath the seafloor. More specifically, the disclosure relates to a system for detection and delineation of conductive bodies situated upon and/or beneath the seafloor and a method of detection and delineation of conductive bodies situated upon and/or beneath the seafloor as defined in the introductory parts of claim 1 and claim 10.

### Related Art

Electromagnetic methods are based on the physics described by Maxwell in 1873, where he demonstrated how electric and magnetic fields propagate through a medium altering and generating each other. Geophysicists have been using these physical laws and their mathematical consequences to explore the subsurface since then. However, for very long time, the geophysical electromagnetic methods have been mainly used on land due to the challenges related to the filtering effect of the highly conductive seawater, which affects penetration of useful amounts of electromagnetic field through the body of water separating the source and receivers from the features of interest upon or beneath the seafloor, as well as high costs of marine operations. These challenges have been overcome with the transition of oil & gas industry offshore, which became the major driving force behind the rapid development of marine electromagnetics. Modern EM systems have low noise levels, high-precision, and the accuracy performance necessary for measuring the weak electromagnetic field changes caused by resistivity variations in the subsurface, when a powerful electric source is deployed in seawater environment. The commonly used method with an active electromagnetic source is called Controlled Source Electromagnetics (CSEM). In oil & gas applications, CSEM deals with relatively big and deep subsurface targets. In the field of CSEM, applied to large-scale measurements in marine environments with the purpose to characterize the resistivity structure of sediments and rock formations, several research articles have been written and published.

Other common marine applications of EM methods e.g. identification of unexploded ordinance (UXO) or pipeline tracking, on the contrary, focus on the shallow near-surface targets of very small sizes (centimetres to few meters) and mainly deploy passive EM measurements with magnetic or various kinds of electrode sensors. Electromagnetic fields have also been used in mineral exploration to find electrically conductive regions on and below the surface onshore. Offshore, in deep-sea environments where marine minerals are likely to occur, a common exploration methodology includes the use of various high-frequency sonars in conjunction with magnetometer or passive electric field sensors mounted on underwater vehicles. The electromagnetic sensors measure the so called self-potential effect from the mineral deposits.

Some examples of the prior art include U.S. Pat. No. 4,617,518 A which discloses an improved method and apparatus for electromagnetic surveying of a subterranean earth formation beneath a body of water. An electric dipole current source is towed from a survey vessel in a body of water substantially parallel to the surface of the body of water and separated from the floor of the body of water by a distance less than approximately one-quarter of the distance between the surface and the floor. Alternating electric current, preferably including a plurality of sinusoidal components, is caused to flow in the source. An array of electric dipole detectors is towed from the survey vessel substantially collinearly with the current source. Each electric dipole detector of the array is separated from the current source by a distance substantially equal to an integral number of wavelengths of electromagnetic radiation, of frequency equal to that of a sinusoidal component of the source current, propagating in the water. A gradient detector array is also towed by the survey vessel in a position laterally separated from, or beneath, the mid-point of the current source. Additionally, an array of three-axis magnetic field sensors mounted in controllable instrument pods are towed by the seismic survey vessel on the flanks of the current source. Frequency-domain and time-domain measurements of magnetic and electric field data are obtained and analyzed to permit detection of hydrocarbons or other mineral deposits, or regions altered by their presence, within subfloor geologic formations covered by the body of water.

U.S. Pat. No. 7,737,698 B2 discloses a detector for a marine electromagnetic survey system includes a housing arranged to minimize turbulence when the housing is towed through a body of water, and to minimize motion of the housing in any direction other than the tow direction. The housing includes at least one of an electric field and a magnetic field sensing element associated therewith.

U.S. Pat. No. 9,459,368 B2 discloses an electromagnetic survey acquisition system includes a sensor cable and a source cable, each deployable in a body of water, and a recording system. The sensor cable includes an electromagnetic sensor thereon. The source cable includes an electromagnetic antenna thereon. The recording system includes a source current generator, a current sensor, and an acquisition controller. The source current generator powers the source cable to emit an electromagnetic field from the antenna. The current sensor is coupled to the source current generator. The acquisition controller interrogates the electromagnetic sensor and the current sensor at selected times in a synchronized fashion.

U.S. Pat. No. 10,871,590 B2 discloses an Electromagnetic (EM) inversion that includes determining an electric field associated with EM data within a predetermined sensitivity area around each of a plurality of source positions, iteratively inverting the electric field for a subsurface resistivity EM model indicative of a subterranean formation for each of a plurality of EM electrical resistivity data cells within each of the predetermined sensitivity areas, and storing results of the iterative inversion. A linear system of equations comprising a Jacobian matrix is generated based on the iterative inversion, the linear system of equations is stored, and the linear system of equations is solved at each iteration of the iterative inversion to update the subsurface resistivity EM model until a convergence criterion is met. A resistivity map based on the updated subsurface resistivity EM model can be produced.

U.S. Pat. No. 8,990,019 B2 discloses an apparatus and methods for determining characteristics of a target region which is embedded in background material below a body of water. In accordance with one embodiment, a resistivity background is determined. In addition, characteristics of an electric dipole due to the target region are determined. A resistance for the target region is then computed using the characteristics of the electric dipole and the resistivity background. Other embodiments, aspects and features are also disclosed.

U.S. Pat. No. 20,210,94660 Al discloses a method that includes receiving electric field data regarding an electric field that is detected in an underwater environment by a plurality of electrodes mounted on a first structure, and receiving sensor data from at least one sensor mounted on the first structure. The sensor data relates to a sensed location of a second structure. The method includes determining location data including information regarding a location of the second structure relative to the first structure in the underwater environment based on the sensor data, and determining one or more characteristics of the second structure based on the electric field data and the location data.

### SUMMARY

According to a first aspect there is provided a system for detection and delineation of conductive bodies situated upon and/or beneath the seafloor, system comprising at least one source Autonomous Underwater Vehicle having a hull and at least one receiver Autonomous Underwater Vehicle having a hull, the source AUV comprising: a controlled electric dipole source mounted on the hull of the source AUV; first magnetometers mounted inside the hull of the source AUV; the receiver AUV comprising; first receiver electrodes; second receiver electrodes; second magnetometers mounted inside the hull of the AUV; measurement electronics hosted inside the receiver AUV; wherein the first and the second magnetometers are configured to measure the magnetic field and the first and the second receiver electrodes are configured to measure electric field in a horizontal direction relative to the AUV and a vertical direction relative to the AUV when electromagnetic energy is transmitted from the controlled electric dipole source.

According to aspect further embodiment there is provided a system for detection and delineation of conductive bodies situated upon and/or beneath the seafloor, system comprising at least one Autonomous Underwater Vehicle that acts as both the source AUV and the receiver AUV having a hull comprising: a controlled electric dipole source mounted on the hull of the AUV; magnetometer mounted inside the hull of the AUV; receiver electrodes; measurement electronics hosted inside the AUV; wherein the magnetometer is configured to measure the magnetic field and the receiver electrodes are configured to measure electric field in a horizontal direction relative to the AUV and a vertical direction relative to the AUV when electromagnetic energy is transmitted from the controlled electric dipole source.

According to some embodiments, the controlled electric dipole source comprises at least two metal electrode plates mounted outside the hull of the source AUV.

According to some embodiments, the first receiver comprises a first pair of receiver electrodes mounted on the hull of the AUV and separated from one another in the x-direction and the second receiver comprises a second pair of receiver electrodes mounted on the hull of the AUV and separated from one another in the z-direction.

According to some embodiments, the first and the second magnetometers are 3-axes and/or total field magnetometers.

According to some embodiments, the source AUV further comprises source electronics hosted inside the source AUV and connected to the two electrode plates with cables through the hull, the source electronics adapted to operate the electric dipole source.

According to some embodiments, the source AUV and receiver AUV further comprise measurement electronics adapted to operate the receiver electrodes and the first and the second magnetometers.

According to some embodiments, the source AUV and the receiver AUV further comprise a battery for powering the electric dipole source, first and second receivers, source and measurement electronics and the magnetometer.

According to some embodiments, the controlled electric dipole source operate in the frequency range between 1 and 100 Hz.

According to some embodiments, the system further comprises a processor which is configured to use measurements from the first and second magnetometers and first and second receiver electrodes to create a conductivity structure of the conductive bodies.

According to a second aspect there is provided a method of detection and delineation of conductive bodies situated upon and/or beneath the seafloor, the method comprising steps of:—transmitting electromagnetic energy from a source AUV having a hull equipped with a controlled electric dipole source;—measuring electric field with a first and second receiver electrodes mounted on a hull of a receiver AUV;—measuring magnetic field with first magnetometers mounted in the hull of the source AUV and second magnetometers mounted in the hull of the receiver AUV, wherein the source and the receiver AUVs are moving along a survey line. The movement pattern may be defined in a predefined pattern.

According to some embodiments, the method comprises a first pair of receiver electrodes mounted on the hull of the receiver AUV and separated from one another in the x-direction and the second receiver comprising a second pair of receiver electrodes mounted on the hull of the receiver AUV and separated from one another in the z-direction.

According to some embodiments, the first pair of receiver electrodes and the second pair of receiver electrodes having an offset of 30-50 meter to the controlled electric dipole source.

According to some embodiments, the electromagnetic energy transmitted by the controlled electric dipole source containing discrete frequencies between 1 and 10 Hz.

According to some embodiments, the controlled electric dipole source having a 15 seconds long output sequence.

According to some embodiments, the source and the receiver AUVs being 30 meters above seafloor.

According to some embodiments, obtaining conductivity structure of the conductive bodies by feeding the measured electric field and magnetic field to a trained Convolutional Neural Network.

According to some embodiments, the conductive bodies being hydrothermal vent fields and/or marine mineral deposits such as ferromanganese crusts, seafloor massive sulfides, and polymetallic nodules.

According to some embodiments, the method further the method comprises a processor which is configured using measurements from the first and second magnetometers and first and second receiver electrodes to creating a conductivity structure of the conductive bodies.

Effects and features of the second aspect are to a large extent analogous to those described above in connection with the first aspect. Embodiments mentioned in relation to the first aspect are largely compatible with the second aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### Definitions

The terms horizontal, vertical and x-, y-, and z-directions shall not be bound by a traditional horizontal, vertical, x, y, and z orthogonal environments, but shall be understood to represent any various different directions in a 3D environment, also comprising non-orthogonal directions.

### BRIEF DESCRIPTIONS OF THE DRAWINGS

The features and advantages of the present disclosure, will be more fully appreciated by reference to the following illustrative and non-limiting detailed description of example embodiments of the present disclosure, when taken in conjunction with the accompanying drawings.

FIG. 1a shows a schematic illustration of an electromagnetic data acquisition system using two Autonomous Underwater Vehicles.

FIG. 1b shows a schematic illustration of an electromagnetic data acquisition system using a single Autonomous Underwater Vehicles.

FIG. 2a shows a vertical cross-section of the data acquisition model geometry.

FIG. 2b shows a horizontal cross-section of the data acquisition model geometry.

FIG. 3a shows a plot of frequency versus inline offset and sensitivity for electric field x-component.

FIG. 3b shows a plot of frequency versus inline offset and sensitivity for the electric field z-component.

FIG. 3c shows a plot of frequency versus inline offset and sensitivity for the magnetic y-component.

FIGS. 4a and 4b show graphs of inline offset versus magnitude of the electric field x- and z-components at a representative frequency of 3 Hz.

FIG. 4c shows a graph of inline offset versus magnitude of the magnetic field y-component at a representative frequency of 3 Hz.

FIGS. 5a-5c show graphs of the source-receiver mid point position versus the magnitude of the electric field x, z-components and the magnetic field y-component at a frequency of 3 Hz and offset of 50 meters.

FIGS. 6a-6c show graphs of the source-receiver mid point position versus the magnitude of the electric field x, z-components and the magnetic field y-component at a frequency of 3 Hz and offset of 30 meters.

FIGS. 7a-7c show graphs of the source-receiver mid point position versus the magnitude of the electric field x, z-components and the magnetic field y-component at a frequency of 3 Hz and offset of 3 meters.

FIGS. 8a and 8b show the magnitude of the electric field z-component in grey scale at 50 meters offset with and without noise added.

FIGS. 9a and 9b show the magnitude of the magnetic field y-component in grey scale at 3 meters offset with and without noise added.

FIG. 10 shows a schematic illustration of an electromagnetic data acquisition system using a single Autonomous Underwater Vehicles having multiple pairs of receiver electrodes.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

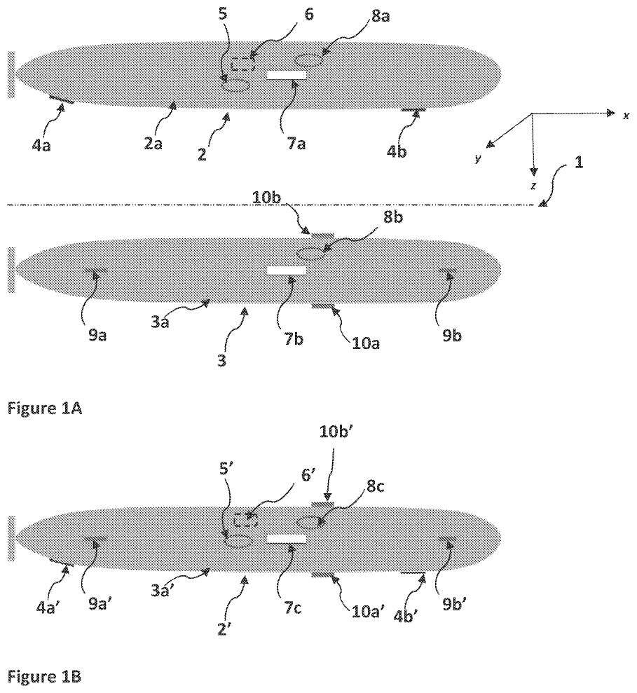

FIG. 1a shows an electromagnetic data acquisition system using Autonomous Underwater Vehicles, referred to as AUVs from hereon. The system comprises at least one source AUV 2 and at least one receiver AUV 3. The source AUV 2 is equipped with a controlled electric dipole source comprising at least two metal electrode plates 4a, 4b mounted on the hull of the source AUV 2. In this embodiment, the controlled electric dipole sources are mounted on the outside of the hull, on the bottom part of the hull.

The system further comprises source electronics 5 which in this embodiment are located inside the source AUV 2. The source electronics 5 are connected to the two electrode plates 4a and 4b with cables (not shown) through the hull, and are adapted to operate the controlled electric dipole source. The source electronics 5 may be powered with a battery 6 inside the hull of the AUV 2 with a sufficient capacity for e.g. a 12-hour survey.

The system further comprises first and second magnetometers 7a, 7b, which are configured for measuring the magnetic field. One or both of the first and second magnetometers 7a, 7b may be 3-axes and/or total field magnetometer. The first magnetometer 7a is mounted on the source AUV 2, in this embodiment, inside the hull of the source AUV 2. The second magnetometer 7b, is mounted on the received AUV 3, in this embodiment inside the hull of the AUV 3.

The receiver AUV 3 further comprises first pair of receiver electrodes 9a and 9b, which in this embodiment are mounted outside the hull of the AUV 3. The first pair of receiver electrodes 9a, 9b are separated from one another in an x-direction. The receiver AUV 3 is also provided with a second pair of receiver electrodes 10a, 10b, which in this embodiment are mounted on the outside the hull of the AUV 3. The second pair of receiver electrodes 10a, 10b are separated from one another in a z-direction which is perpendicular to the x-direction. The first and the second pairs of receiver electrodes 9a, 9b, 10a, 10b are adapted to measure a resulting electric field in the x-direction and the z-direction) respectively when suitable signal shapes are transmitted from the metal electrode plates 4a and 4b of the source AUV 2.

The received AUV 3 is also provided with measurement electronics 8b, which in this embodiment are located inside the receiver AUV 3. The measurement electronics 8a and 8b are adapted to operate the receiver electrodes 9a, 9b, 10a, 10b and the first and the second magnetometers 7a and 7b. The measurement electronics 8a are galvanically isolated from the source electronics 5 to avoid potential cross feed between them. The measurement electronics 8a, 8b may include a 24-bit AD-converter with suitable amplifier to get sufficient dynamic range and amplification for the receiver electrodes and magnetometers.

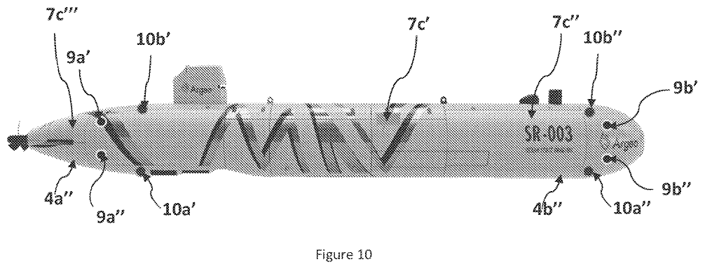

The examples are showing one source electronics 5 connected to a pair of two electrode plates 4a and 4b, a first and second magnetometers 7a, 7b, and two pairs of receiver electrodes 9a, 9b, 10a, 10b measuring electric fields in two directions, but the present disclosure shall also be understood to be implemented with two or more electrode paired plates 4a′ and 4b′, magnetometer pairs 7c′, 7c″, 7c′″, electrode pairs 9a′, 9b′, 10a′, 10b′, 9a″, 9b″, 10a″, 10b″, in any direction to provide for more redundancy in the measurements and more accurate estimation of the full electric field. The latter is exemplified in FIG. 10, where there are seen two horizontal electrode pairs and two vertical pairs on the side facing the viewer. Corresponding additional pairs may be provided on the opposite side of the hull. It is also possible to connect the pairs in a diagonal pattern, for example by a pair composed of 9a′ and 9b″, or in any pattern.

Although, figure la shows the source AUV 2 with only two metal electrode plates, the source AUV 2 may comprise more than two metal electrodes and the receiver AUV 3 may comprise of additional receiver electrodes and magnetometers.

When acquiring electromagnetic data, the source AUV 2 and the receiver AUV 3 may be set up to run in an in-line configuration, in which the source AUV 2 and receiver AUV 3 are operated to move along suitably defined survey lines 1 covering an area of interest.

The survey lines 1 are parallel to the x-direction mentioned above in relation to the receiver electrodes 9a, 9b, 10a, 10b, so that the first pair of receiver electrodes 9a, 9b measure the electric field parallel to the survey lines 1 (in the inline direction). The receiver AUV 3 is configured such the z-direction referred to above in relation to the second pair of receiver electrodes 10a, 10b is generally vertical as the AUV 3 moves along the survey lines 1, so that the second pair of receiver electrodes measure the vertical components of the electric field. The system may further comprise a processor which is configured to use measurements from the first 7a and second magnetometers 7b and first 9 and second receiver electrodes 10 to generate a conductivity map/structure of the conductive bodies at the area of interest.

The area of interest may be an area with marine mineral deposits such as polymetallic nodules, ferromanganese crusts, and seafloor massive sulfides (SMS) or hydrothermal venting fields. The source signal contains discrete frequencies between 1 and 10 Hz and the integration time may be set to be at least 15 s. This ensures sufficient sensitivity and signal-to-noise ratio when the AUVs are moving along a survey line 1 with the receiver AUV 3 in the range of 30-50 m behind the source AUV 2 when both AUVs are 30 m above the seafloor. The source 4a, 4b of the AUV 2 transmits electromagnetic energy towards the seafloor, the receiver electrodes 9, 10 on the receiver AUV 3 record the electric field components of the area of interest and the magnetometers 7a, 7b on the source AUV 2 and the receiver AUV 3 record the magnetic field of the area of interest.

Only the source AUV 2 may be utilized to acquire the data (zero offset), but then only data from the magnetometer 7a. However, such measurement configuration would degrade the delineation of the conductive region. If the source AUV 2 is equipped with receiver electrodes 9a and 9b, then depth penetration would be reduced due to the lack of sufficient offset between the source and the receivers. The two-AUV configuration is preferable for the enhancement of conductivity delineation processing, i.e. to reduce the ambiguities in the results for larger bodies such as SMS deposits.

However, according to the present disclosure it Is also provided a system for detection and delineation of conductive bodies situated upon and/or beneath the seafloor, system comprising at least one Autonomous Underwater Vehicle that acts as both the source AUV and the receiver AUV described above. Thus the single AUV as described in FIG. 1b having a hull comprising: a controlled electric dipole source mounted on the hull of the AUV 2′; magnetometer mounted inside the hull of the AUV 7c; receiver electrodes 9a′, 9b′, 10a′, 10b′; measurement electronics 8c hosted inside the AUV 2′; wherein the magnetometer 7c is configured to measure the magnetic field and the receiver electrodes 9a′, 9b′, 10a′, 10b′ are configured to measure electric field in a horizontal direction relative to the AUV and a vertical direction relative to the AUV when electromagnetic energy is transmitted from the controlled electric dipole source 4a′, 4b′.

For thin bodies such as polymetallic crusts or polymetallic nodules, single AUV configuration, as shown in FIG. 1b, is preferable for better sensitivity in depth. Delineation of the conductive region procedure may consist of data inversion in various detail. For example, a very rough conductivity structure can be inverted for with a limited dataset to get a fast and approximate result. A more detailed structure can be estimated through inversion of larger datasets. For example, a 3D-structure can be obtained by jointly inverting data from several parallel survey lines 1.

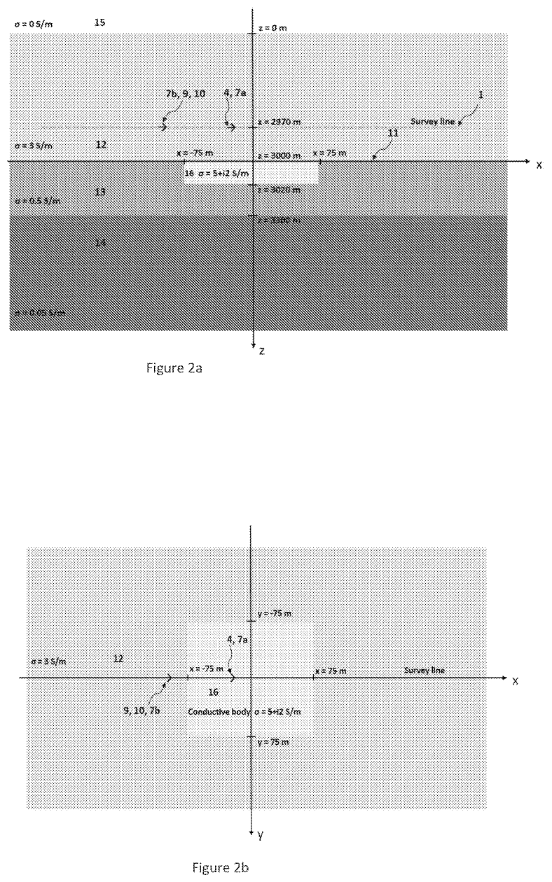

To test the feasibility of the invention, various electromagnetic source and receiver configurations were numerically modelled in a 3D-geometry of a simplified marine environment representative of seafloor massive sulfide (SMS) deposit hosted in a simple layered medium. FIG. 2 shows a vertical and a horizontal cross-section of the model geometry respectively. In the modelling, the AUVs are moving along a survey line 1 with the receiver AUV 3 in an offset range of 30-50 m behind the source AUV 2, both AUVs are 30 m above the seafloor 11. The area of interest consists of a 3000-m deep seawater layer 12 with a conductivity σ of 3 S/m. Below the seafloor 11 follows a 300-m thick rock layer 13 with a conductivity σ of 0.5 S/m. A semi-infinite layer 14 of 0.05 S/m underlays both layers 12 and 13. In this case, the air is also represented as the uppermost semi-infinite layer 15 but with zero conductivity.

To model a simplified version of an SMS deposit, a homogeneous box 16 of complex conductivity σ of 5+i*2 S/m is placed under the seafloor 11 in FIG. 2a. The horizontal extent is 150×150 m and the thickness is 20 m. FIG. 2b shows the homogeneous conductive body 16.

A survey line 1 is placed in the water column 30 m above the seafloor 11 and centered above the conductivity box 16. The source and receiver positions are marked with arrows traversing the survey line 1 from left to right.

In the modelling, a source strength of 500 Am is used. The electrode plates 4a, 4b have a separation of 5 m which implies a source current of 100 A. A typical voltage needed to drive this current is 24 V. Hence, the source effect would be 2400 W; a battery capacity of about 30 kWh would be needed to run the source for 12 hours.

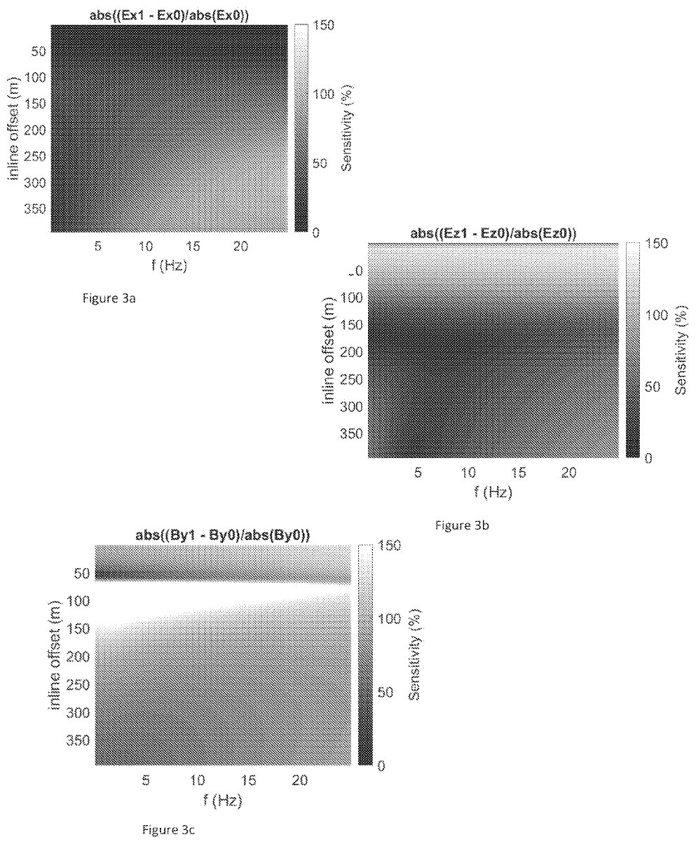

An investigation of suitable electromagnetic frequencies and offsets for best sensitivity demonstrates that frequencies in the range from 1 to 100 Hz provide acceptable sensitivity to the conductive body in some of the electromagnetic field components. This is illustrated in in FIG. 3 in which the relative sensitivities in percent for the non-zero electromagnetic field components are plotted. The sensitivity is the change in the electromagnetic field when the conductive body 16 is added to the background environment. This change is then normalized with the electromagnetic field without the conductive body 16 and multiplied by 100 to get the relative change in percent in FIGS. 3a-c. FIG. 3a shows the electric x-component, FIG. 3b shows the electric z-component and FIG. 3c shows the magnetic y-component. It can be noted in FIG. 3c that there is a very high sensitivity region for the magnetic y-component for offsets around 80 m. However, as will be seen in the analysis below, the field itself is below the signal-to-noise ratio which then excludes this high sensitivity region. In fact, the signal-to-noise ratio needs to be sufficient for a sensitive region to be valid.

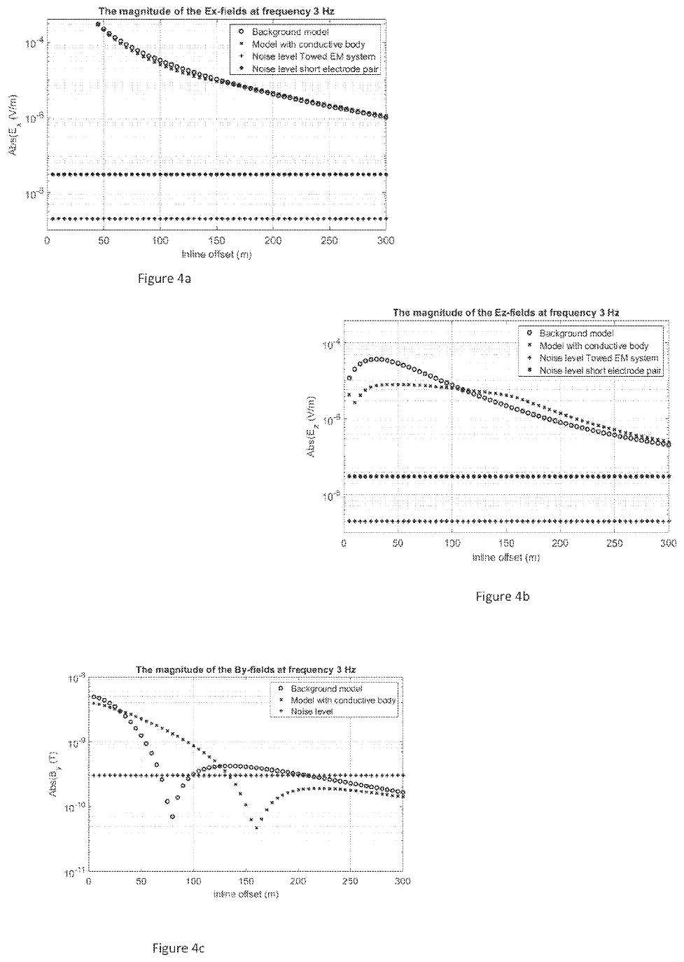

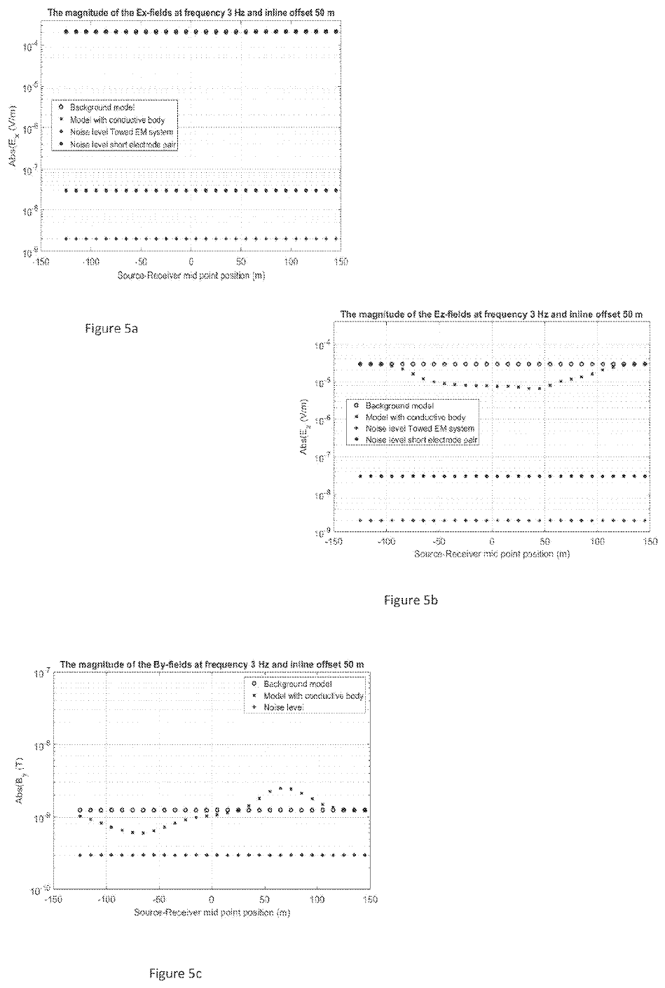

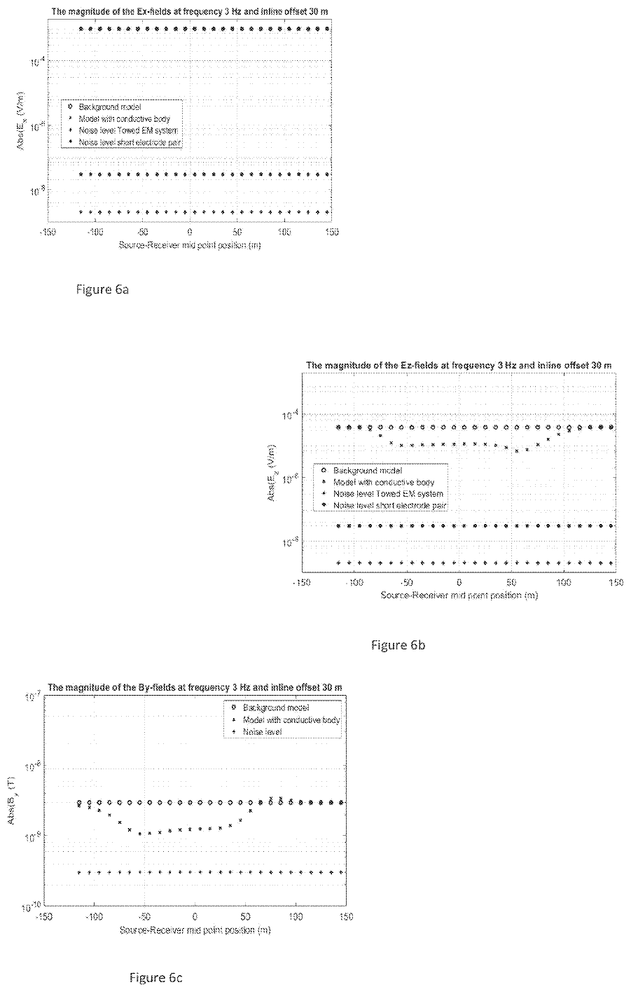

The offset dependencies at a representative frequency of 3 Hz, for the non-zero field components, are shown in FIGS. 4a-4c. In these figures, the source position along the survey line is x=80 m. The resulting magnetic (FIG. 4c) and electric fields (FIGS. 4a and 4b) with the conductivity body 16 present, are plotted with crosses (x) and the fields without the body 16 with hollow circles (o). Representative noise values are plotted with filled circles (⋅) for the electric field and with plus symbols (+) for the magnetic field. The same notations are used in FIGS. 5-7 below.

Based on the results displayed in FIGS. 4a-4c, it can be concluded that the inline Ex-component is not useful for detection of conductive bodies which is opposite to resistive body detection in an oil-and-gas application. Here, in a conductive body case, there is a good sensitivity to the vertical Ez-component of electric field as well as to the magnetic field (By-component in this case). This behavior is also seen in FIGS. 5-7.

Furthermore, in FIGS. 4a-4c, it can also be seen that both the Ez-and By-components have good sensitivity for the whole offset range 0-300 m at 3 Hz. However, the signal-to-noise ratio becomes too low for the magnetic field with offsets longer than 50-60 m. Hence, with a source strength of 500 Am, offsets between 0 and 50 m are most suitable. A larger offset range could be achieved with a stronger source. However, that would impose a shorter limit on the duration of the survey because of higher energy consumption from the battery if the battery size is the same.

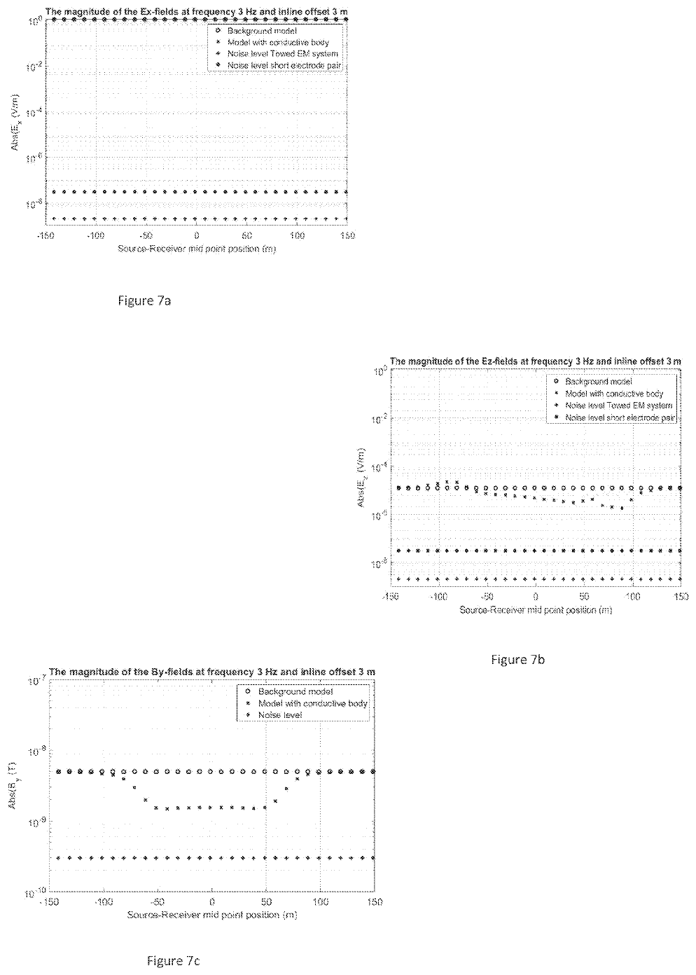

FIGS. 5-7 show the non-zero field components at a frequency of 3 Hz at three fixed offsets of 50, 30 and 3 meters respectively. The sensitivities for Ez and By are sufficient in all three cases. However, the signal-to-noise ratio for the By field is too low with the 50 m offset, FIG. 5c. The best signal-to-noise ratio for the By field is obtained at the shortest offset (3 m), FIG. 7c. The sensitivity is, in fact, highest for this offset. For the electric field component, the situation is opposite. The most suitable offset is 50 m, as shown in FIG. 5b. The reason is the smallest ratio of Ex/Ez at that offset.

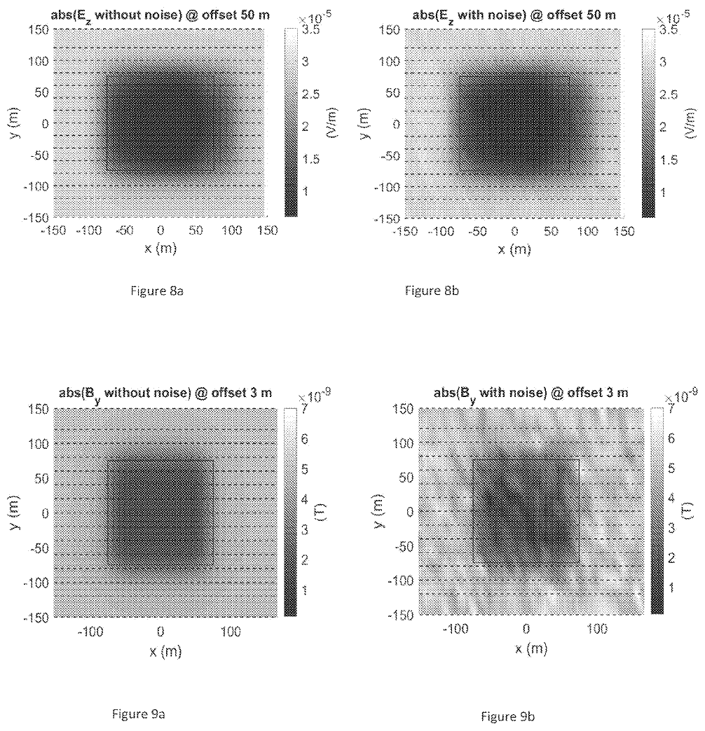

To further demonstrate the sensitivity as well as the effect from adding realistic white noise to modelled data, twelve additional survey lines have been added to the one at y=0. Thirteen parallel lines visualized as dotted horizontal lines in FIGS. 8 and 9, have been used to calculate the electromagnetic fields over a survey grid with source positions from x=−150 m to x=170 m for y=−150 m to y=150 m at z=2970 m. The white noise has a mean value according to the noise lines in FIGS. 4-7. A standard deviation of twice the mean value is used to simulate variations of the noise along the survey lines. The generated noise for each source point is then added to the modelled electric and magnetic fields, respectively. FIGS. 8 and 9 show the magnitudes of the electric Ez and magnetic By components for the offsets 50 m and 3 m, respectively. The frequency is 3 Hz, as before. The selection of offsets is based on the modelling results shown in FIGS. 4-7. Based on these results, the most optimal offsets for these components have been chosen.

It can clearly be seen in FIGS. 8 and 9 that the horizontal extent of the conductive body can be determined solely by inspecting the magnitudes of the selected field components. The addition of noise affects this estimation of the horizontal extent only slightly. This suggests that a part of the delineation can in fact be done by using the electromagnetic fields directly for a suitable measurement configuration. However, a more detailed property estimation of the conductive body requires data inversion or similar.

The first aspect of this disclosure shows a system for detection and delineation of conductive bodies situated upon and/or beneath the seafloor, system comprising at least one source Autonomous Underwater Vehicle AUV the aspect having a hull 2a and at least one receiver Autonomous Underwater Vehicle AUV 3 having a hull 3a, the source AUV 2 comprising: a controlled electric dipole source mounted on the hull of the source AUV 2; first magnetometers 7a mounted on the hull 2a of the source AUV 2; the receiver AUV 3 comprising; first receiver electrodes 9; second receiver electrodes 10; second magnetometers 7b mounted inside the hull of the AUV 3; measurement electronics 8b hosted inside the receiver AUV 3; wherein the first and the second magnetometers 7a, 7b are configured to measure the magnetic field and the first and the second receiver electrodes 9,10 are configured to measure electric field in a horizontal direction relative to the AUV 3 x-direction and a vertical direction relative to the AUV 3 z-direction when electromagnetic energy is transmitted from the controlled electric dipole source.

The controlled electric dipole source comprises at least two metal electrode plates 4a,4b mounted outside the hull of the source AUV 2.

The first receiver comprises a first pair of receiver electrodes 9a,9b mounted on the hull 3a of the AUV 3 and separated from one another in the x-direction and the second receiver comprises a second pair of receiver electrodes 10a, 10b mounted on the hull 3a of the AUV 3 and separated from one another in the z-direction.

The first and the second magnetometers 7a,7b are 3-axes and/or total field magnetometers.

The source AUV 2 further comprises source electronics 5 hosted inside the source AUV 2 and connected to the two electrode plates 4a,4b with cables through the hull, the source electronics adapted to operate the electric dipole source.

The source AUV 2 and receiver AUV 3 further comprise measurement electronics 8a,8b adapted to operate the receiver electrodes 9,10 and the first and the second magnetometers 7a, 7b.

The source AUV 2 and the receiver AUV 3 further comprise a battery for powering the electric dipole source, first and second receivers, source and measurement electronics and the magnetometer.

The controlled electric dipole source operate in the frequency range between 1 and 10 Hz.

The system further comprises a processor which is configured to use measurements from the first 7a and second magnetometers 7b and first 9 and second receiver electrodes 10 to create a conductivity structure of the conductive bodies.

The second aspect of this disclosure shows a method of detection and delineation of conductive bodies situated upon and/or beneath the seafloor, the method comprising steps of:—transmitting electromagnetic energy from a source AUV 2 having a hull 2a equipped with a controlled electric dipole source;—measuring electric field with a first and second receiver electrodes 9,10 mounted on a hull 3a of a receiver AUV 3;—measuring magnetic field with first magnetometers 7a mounted inside the hull 2a of the source AUV 2 and second magnetometers 7b mounted inside the hull 3a of the receiver AUV 3, wherein the source and the receiver AUVs are moving along a survey line 1.

The first receiver comprises a first pair of receiver electrodes 9a,9b mounted on the hull 3a of the receiver AUV 3 and separated from one another in the x-direction and the second receiver comprising a second pair of receiver electrodes 10a, 10b mounted on the hull 3a of the receiver AUV 3 and separated from one another in the z-direction.

The first pair of receiver electrodes and the second pair of receiver electrodes having an offset of 30-50 meter to the controlled electric dipole source.

The electromagnetic energy transmitted by the controlled electric dipole source containing discrete frequencies between 1 and 10 Hz.

The controlled electric dipole source having a 15 seconds long output sequence.

The source and the receiver AUVs being 30 meters above seafloor.

Obtaining conductivity structure of the conductive bodies by feeding the measured electric field and magnetic field to a trained Convolutional Neural Network.

The conductive bodies being hydrothermal vent fields and/or marine mineral deposits such as ferromanganese crusts, seafloor massive sulfides.

The method further comprises a processor which is configured using measurements from the first 7a and second magnetometers 7b and first 9 and second receiver electrodes 10 to creating a conductivity structure of the conductive bodies.

The person skilled in the art realizes that the present disclosure is not limited to the preferred embodiments described above.

1. A system for detection and delineation of one or more conductive bodies situated at least one of upon or beneath a seafloor, comprising:
a source AUV (Autonomous Underwater Vehicle) having a hull; and
a receiver AUV having a hull;
wherein the source AUV comprises:
a controlled electric dipole source mounted on the hull of the source AUV; and
a first magnetometer mounted inside the hull of the source AUV;
wherein the receiver AUV comprises:
a first pair of receiver electrodes;
a second pair of receiver electrodes;
a second magnetometer mounted inside the hull of the receiver AUV; and
a plurality of measurement electronics hosted inside the receiver AUV to operate the first pair of receiver electrodes, the second pair of receiver electrodes, the first magnetometer, and the second magnetometer;
wherein the controlled electric dipole source comprises at least two metal electrode plates mounted outside the hull of the source AUV;
wherein the first magnetometer and the second magnetometer are configured to measure a magnetic field, and the first pair of receiver electrodes and the second pair of receiver electrodes are configured to measure an electric field in a horizontal direction (x-direction) and in a vertical direction (z-direction) relative to the receiver AUV when electromagnetic energy is transmitted from the controlled electric dipole source, wherein the first pair of receiver electrodes and the second pair of receiver electrodes each have an offset in a range of 30-50 meters from the controlled electric dipole source, and
the system further comprising:
a plurality of source electronics hosted inside the source AUV and connected to the at least two metal electrode plates with cables through the hull of the source AUV adapted to operate the controlled electric dipole source; and
a battery for powering the controlled electric dipole source, the first pair of receiver electrodes and the second pair of receiver electrodes, the plurality of source electronics, the plurality of measurement electronics, and the first magnetometer and the second magnetometer.

2. (canceled)

3. The system according to claim 1, wherein:
the first pair of receiver electrodes are mounted on the hull of the receiver AUV and separated from one another in the x-direction; and
the second pair of receiver electrodes are mounted on the hull of the receiver AUV and separated from one another in the z-direction.

4. The system according to claim 1, wherein the first magnetometer and the second magnetometer are at least one of 3-axes or total field magnetometers.

5. The system according to claim 1, wherein the controlled electric dipole source operates in a frequency range of 1-100 Hz.

6. The system according to claim 1, further comprising a processor configured to use measurements from the first magnetometer, the second magnetometer, the first pair of receiver electrodes, and the second pair of receiver electrodes to create a conductivity structure of the one or more conductive bodies.

7. The system according to claim 1, the system comprising an AUV that acts as both the source AUV and the receiver AUV, the AUV having a hull comprising:
a controlled electric dipole source mounted on the hull of the AUV;
a plurality of magnetometers mounted inside the hull of the AUV;
a plurality of receiver electrode pairs; and
a plurality of measurement electronics hosted inside the AUV;
wherein the plurality of magnetometers are configured to measure the magnetic field, and the plurality of receiver electrode pairs are configured to measure the electric field in the horizontal direction (x-direction) and in a vertical direction (z-direction) relative to the AUV when electromagnetic energy is transmitted from the controlled electric dipole source.

8. A method of detection and delineation of one or more conductive bodies situated at least one of upon or beneath a seafloor, the method comprising:
transmitting electromagnetic energy from a source AUV (Autonomous Underwater Vehicle) having a hull equipped with a controlled electric dipole source;
measuring an electric field with at least one first receiver and at least one second receiver mounted on a hull of a receiver AUV, wherein the at least one first receiver comprises at least one a first pair of receiver electrodes mounted on the hull of the receiver AUV and separated from one another in a horizontal direction (x-direction), and wherein the at least one second receiver comprises a second pair of receiver electrodes mounted on the hull of the receiver AUV and separated from one another in a vertical direction (z-direction), wherein the first pair of receiver electrodes and the second pair of receiver electrodes each have an offset of 30-50 meters from the controlled electric dipole source; and
measuring a magnetic field with at least one first magnetometer mounted inside the hull of the source AUV and at least one second magnetometer mounted inside the hull of the receiver AUV, wherein the source AUV and the receiver AUV are moving along a survey line.

9. (canceled)

10. The method according to claim 8, wherein the electromagnetic energy transmitted by the controlled electric dipole source contains discrete frequencies in a frequency range of 1-100 Hz.

11. The method according to claim 8, wherein the controlled electric dipole source has a 15-second output sequence.

12. The method according to claim 8, wherein the source AUV and the receiver AUV are 30 meters above the seafloor.

13. The method according to claim 8, further comprising obtaining a conductivity structure of the one or more conductive bodies by feeding an electric field measurement and a magnetic field measurement to a trained Convolutional Neural Network.

14. The method according to claim 8, wherein the one or more conductive bodies are hydrothermal at least one of vent fields or marine mineral deposits comprising ferromanganese crusts, seafloor massive sulfides, or polymetallic nodules.

15. The method according to claim 8, further comprising a processor configured to use magnetic field measurements from the at least one first magnetometer and the at least one second magnetometer, and electric field measurements from the first pair of receiver electrodes and the second pair of receiver electrodes to create a conductivity structure of the one or more conductive bodies.
